(19) United States
(12) Patent Application Publication
(10) Pub. No.: US 2020/0242657 A1
(43) Pub. Date: Jul. 30, 2020

(54) Advertisement Creation and Auction Platform for Audio Clips

(71) Applicant: Audiobyte LLC, Port Washington, NY (US)

(72) Inventors: Andrew Lawrence Blacker, Port Washington, NY (US); Kristin Asleson McDonnell, Menlo Park, CA (US); John vanSuchtelen, San Francisco, CA (US); Omar Aguirre-Suarez, Fremont, CA (US)

(21) Appl. No.: 16/749,944

(22) Filed: Jan. 22, 2020

Related U.S. Application Data
(60) Provisional application No. 62/798,383, filed on Jan. 29, 2019.

(51) Int. Cl. G06Q 30/02; G06F 3/16; G06N 20/00

(52) U.S. Cl. CPC G06Q 30/0244; G06N 20/00; G06F 3/165; G06Q 30/0276

(57) ABSTRACT

Embodiments of the present technology provide systems and methods for creating digital advertisements using an advertisement creation and auction platform. Systems may comprise a first interface configured to select content to be used in creating a digital advertisement and to receive input from an advertiser, the input comprising advertisement campaign objectives and an audio clip asset creation engine configured to create a plurality of audio clip assets. Systems may further comprise a digital advertisement creation engine configured to automatically select an audio clip asset of the plurality of audio clip assets based on the advertisement campaign objectives, merge the audio clip asset with the content, and generate the digital advertisement. Systems may also include a user feedback engine configured to monitor and analyze user behavior in response to the digital advertisement and generate feedback metrics to improve the digital advertisement.

### CROSS REFERENCE TO RELATED APPLICATION

This Patent Application claims domestic benefit of U.S. Provisional Patent Application Ser. No. 62/798,383, filed Jan. 29, 2019, entitled “Advertisement Creation and Auction Platform for Audio Clips”. The aforementioned disclosure is hereby incorporated by reference herein in its entirety including all references and appendices cited therein.

### FIELD OF THE INVENTION

The present subject matter pertains to multimedia digital content. In particular, but not by way of limitation, the present subject matter provides systems and methods for creating digital advertisements (also referred to herein as ads) using an advertisement creation and auction platform for fully licensed audio clips.

### BACKGROUND

For some advertisers, it can be a difficult, time consuming, and expensive to license popular music for digital advertisement (ad) campaigns. Licensing music requires at least direct conversations between licensors and licensees, legal expenses, and licensing expenses. Sometimes it is difficult to even determine which music labels and publishers own the licenses to a specific piece of music. Thus, only the largest brands and biggest advertising agencies have been able to access popular music for their ad campaigns such as running television ads or other digital ad campaigns such as YouTube video ads, and the like.

However, there are potentially thousands of advertisers, such as small and medium businesses, that would love to have popular music as part of their ad campaigns if the costs and efforts were not prohibitive.

There remains a need for a self-service, automated platform where an advertiser can easily bid for and license popular music for their ad campaigns. Such a platform would make popular music accessible to thousands of advertisers, benefiting advertisers by making their ads more interesting and engaging and motivating consumers to act, and benefiting the music industry by allowing them to license portions of music, such as audio clips between five to thirty seconds in length. Much of the music that is licensed today for advertising is a fifteen to thirty second portion of audio, for example, for use in television commercials. However, as the ad world moves more towards short form digital advertising that is more in the range of the five to fifteen second duration, an easy way for the music industry and advertisers to work with each other does not exist.

### SUMMARY

In some embodiments, the present disclosure is directed to a system of one or more computers which can be configured to perform particular operations or actions by virtue of having software, firmware, hardware, or a combination thereof installed on the system that in operation causes or cause the system to perform actions and/or method steps as described herein. For example, embodiments may include a system for creating digital advertisements using an advertisement creation and auction platform. In various embodiments the system comprises: (I) a first interface configured to select content to be used in creating a digital advertisement and to receive input from an advertiser, the input comprising advertisement campaign objectives; (II) an audio clip asset creation engine configured to create a plurality of audio clip assets; (III) a digital advertisement creation engine configured to automatically select an audio clip asset of the plurality of audio clip assets based on the advertisement campaign objectives, merge the audio clip asset with the content, and generate the digital advertisement; and (IV) a user feedback engine configured to monitor and analyze user behavior in response to the digital advertisement and generate feedback metrics to improve the digital advertisement.

According to some embodiments, the present technology is directed to a method for creating digital advertisements using an advertisement creation and auction platform, the method comprising: (i) receiving selected content to be used in creating a digital advertisement and to receive input from an advertiser, the input comprising advertisement campaign objectives; (ii) creating a plurality of audio clip assets; (iii) automatically selecting an audio clip asset of the plurality of audio clip assets based on the advertisement campaign objectives; (iv) merging the audio clip asset with the selected content; (v) generating the digital advertisement; and (vi) monitoring and analyzing user behavior in response to the digital advertisement and generate feedback metrics to improve the digital advertisement.

In another embodiment, the present disclosure comprises a non-transitory computer readable medium having embodied thereon instructions being executable by at least one processor to perform a method for creating digital advertisements using an advertisement creation and auction platform, the method comprising: (a) receiving selected content to be used in creating a digital advertisement and to receive input from an advertiser, the input comprising advertisement campaign objectives; (b) creating a plurality of audio clip assets; (c) automatically selecting an audio clip asset of the plurality of audio clip assets based on the advertisement campaign objectives; (d) merging the audio clip asset with the selected content; (e) generating the digital advertisement; and (f) monitoring and analyzing user behavior in response to the digital advertisement and generate feedback metrics to improve the digital advertisement.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 illustrates a block diagram showing an environment within which an advertisement creation and auction platform for audio clips may be implemented, in accordance with some embodiments of the present technology.

FIG. 2 is a block diagram showing various modules of an advertisement creation and auction platform for audio clips, in accordance with various embodiments of the present technology.

FIG. 3 is a process flow diagram showing a method for creating digital advertisements using an advertisement creation and auction platform according to one or more example embodiments.

FIG. 4 illustrates a diagrammatic representation of an example machine in the form of a computing system within which a set of instructions for causing the machine to perform any one or more of the methodologies discussed herein is executed.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and changes can be made without departing from the scope of what is claimed. The following detailed description is, therefore, not to be taken in a limiting sense, and the scope is defined by the appended claims and their equivalents.

The techniques of the embodiments disclosed herein may be implemented using a variety of technologies. For example, the methods described herein may be implemented in software executing on a computing system or in hardware utilizing either a combination of microprocessors or other specially designed application-specific integrated circuits, programmable logic devices, or various combinations thereof. In particular, the methods described herein may be implemented by a series of computer-executable instructions residing on a storage medium, such as a disk drive or computer-readable medium. It should be noted that methods disclosed herein can be implemented by a computer (e.g., a desktop computer, a tablet computer, a laptop computer, and so forth), a game console, a handheld gaming device, a cellular phone, a smart phone, a smart television system, and so forth. Different deployment architectures include servers in-the-cloud, in-house, or hybrid.

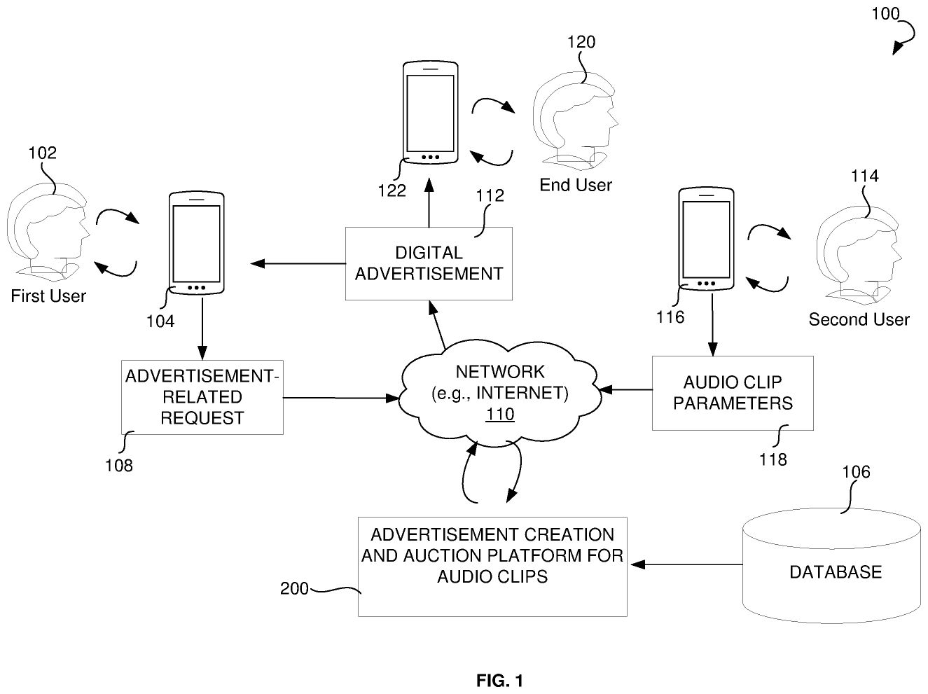

FIG. 1 illustrates an environment 100 within which systems and methods for creating digital ads using an advertisement creation and auction platform for fully licensed audio clips can be implemented, in accordance with some embodiments of the present technology. The environment 100 may include a first user 102, a first user device 104, an advertisement creation and auction platform for audio clips 200 (also referred to as a platform 200), a data network 110 (e.g., the Internet or a computing cloud), a second user 114, a second user device 116, end user(s) 120, end user device(s) 122 and optionally a database 106. The first user device 104, the platform 200, the second user device 116, end user device(s) 122, and the database 106 may be connected via the data network 110.

In various embodiments an advertisement-related request 108 (also referred to herein as ad-related request 108) of the first user 102 (e.g., an advertiser) may be received, for example, via a user interface displayed on the first user device 104. The ad-related request 108 may include text, visual data, or audio data. The text data may be obtained by transcribing a natural language input of the first user 102, by speech-to-text conversion of an oral exchange with the first user 102, or otherwise. In some embodiments, a first user 102 may be one or more advertisers, and the advertiser may login to the platform 200 to define their ad campaign through ad-related request 108. Ad-related request 108 may include visual content uploaded by the advertiser, such as a photo, video, or Graphics Interchange Format (GIF). The ad-related request 108 may also include audio content uploaded by the advertiser, such as an audio file. The ad-related request 108 may include a mood or emotion the advertiser is trying to create, target customers or audience, geographic location of target customers or audience, demographics of the target audience, budget, how many ad impressions the advertiser wants to run, the date that the ad campaign should run, the time-frame or duration during which the ad campaign should run, the format of the advertisement (e.g., mobile, web, or tablet, and the like) and other objectives of the advertiser. In some embodiments, ad-related request 108 may include both visual and audio content, visual content alone, or audio content alone. An example of audio content is a commercial to be played on the radio, SiriusXM®, Pandora®, or any other audio platform. According to another embodiment, no visual or audio content is uploaded by the advertiser, and ad-related request 108 may just be the objectives of the advertiser.

In some embodiments the ad-related request 108 may be transmitted to the platform 200 via the data network 110. The data network 110 may include the Internet or any other network capable of communicating data between devices. Suitable exemplary networks may include or interface with any one or more of, for instance, a local intranet, a Personal Area Network, a Local Area Network, a Wide Area Network, a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The network can further include or interface with any one or more of an RS-232 serial connection, an IEEE-1394 (FireWire) connection, a Fiber Channel connection, an IrDA (infrared) port, a SCSI (Small Computer Systems Interface) connection, a Universal Serial Bus (USB) connection or other wired or wireless, digital or analog interface or connection, mesh or Digi® networking. The data network 110 may be a network of data processing nodes that are interconnected for the purpose of data communication. The data network 110 may include any suitable number and type of devices (e.g., routers and switches) for forwarding commands, content, and/or requests from each user to the platform 200 and responses back to the user.

The first user device 104, in some example embodiments, may include a Graphical User Interface (GUI) for displaying the user interface associated with the platform 200. The first user device 104 may include a mobile telephone, a personal computer (PC), a laptop, a smartphone, a tablet PC, and so forth. The platform 200 may include a server-based distributed application, thus the platform 200 may include a central component residing on a server and one or more client applications residing on one or more user devices and communicating with the central component via the data network 110. The first user 102 may communicate with the platform 200 via a client application available through the first user device 104. In some embodiments, the objectives, the mood, or the emotion the advertiser is trying to create can be a selection from a pre-defined set of options of a drop-down menu of choices of the GUI. The advertiser may also have the option to input their own objectives, moods, or emotions, and the platform 200 can make suggestions. For example, an advertiser may request songs that elicit the feeling of “glee,” and the platform 200 may recommend that the advertiser change “glee” to “happy.” The advertisers may additionally be able to make other selections from the GUI such as genre, beats per minute (BPM), instruments, vocals (e.g., male or female), decade, emotions, vocalist, types of songs such as anthems, ballads, love songs, and the like, as well as how well the song or audio clip has performed in driving consumer behavior in other advertisements such as ad clicks, conversions to paying customers, brand awareness and perception, and customer retention, and the like.

In various embodiments the database 106 may store audio clip assets which may include not only the audio file(s) or documents but also the surrounding aspects, properties, tags, and in general, metadata. In some embodiments, the audio clip is less than the full length of an entire song. For example, an audio clip may range from five to thirty seconds in duration. An audio clip asset may include any information related to the audio clip such as BPM, an emotional graph showing how people respond to portions of the song over time and who responds with a particular emotion, an energy level graph showing how the energy level of the song varies over time, fingerprint, frequency highlights, genre, languages, tags per category, access restrictions, tempo, and relevancy factor. In some embodiments, a tag may be given a value of a graded scale, for example, zero to one hundred to enable fuzzy or standard conditional clauses. For example, an audio clip may not be 100% happy but instead is only 70% happy. A value of 70 may be assigned to that audio clip in the happy category. In some instances, an audio clip may be tagged in one or more categories, and each tag can be given a weighted value for the expression that has been tagged. In some embodiments, audio clips may be automatically tagged by analyzing the text of the audio clips. Audio clips may also be manually tagged or manually tagged in combination with automated tagging.

In some embodiments the database 106 may also store information related to target audiences such as device identifications (also referred to herein as IDs), social media profile information, and the like, or any information that allows the platform 200 to uniquely identify a person or a device. In various embodiments, an application programming interface (API) may be deployed that collects device IDs, social profiles, and the music that resonates with an individual the most and stores the collected data in the database 106.

Audio clip parameters 118 of the second user 114 may be received, for example, via a user interface displayed on the second user device 116. The audio clip parameters 118 may be transmitted to the platform 200 via the data network 110.

In some embodiments, the second user 114 may represent one or more music labels, music publishers, music artists, or any other individuals related to the music industry. The second user 114 may set audio clip parameters 118 such as which kind of music is available for licensing on the platform 200, what is the minimum bid for each piece of music, what's the maximum number of impressions that might be served per month or other time frame, the number of simultaneous ad campaigns that can be run using each individual piece of music. In an exemplary embodiment, a second user 114 may limit the number of impressions of digital advertisement 112 (also referred to herein as digital ad 112) such that the digital ad 112 cannot be shown more than one-million times in a month so as not to overexpose a piece of music. The second user 114 may also set a constraint around frequency. For example, second user 114 may not want to show digital ad 112 to the same person more than three times. In some embodiments, the second user 114 can prohibit a piece of music from being used with a particular category, such as goods or services, competitive music artists, or a specific TV show. For example, a music artist may not want his or her song to be associated with alcohol, tobacco, or some other category. In some embodiments, the second user 114 can make a song available only for specific geographic areas, or for every other month, or if a song has served a certain number of impressions in a certain period of time, the second user 114 can make the song unavailable in order for the song to retain its uniqueness or to drive the value of a particular audio clip higher. Additionally, the second user 114 may set a high minimum bid amount for an audio clip to maintain a higher value for that specific audio clip.

In some embodiments the platform 200 may select an optimal audio clip from the database 106, merge the visual and/or audio content uploaded by the advertiser, if visual and/or audio content is provided by the advertiser, and the audio clip to generate a digital advertisement 112, and present to the first user 102 and/or the end user 120 by displaying digital advertisement 112 via the user interface on a screen of the first user device 104 and/or the end user device 122, respectively. The end user 120 may be one or more members of a target audience that an advertiser is interested in reaching with the advertiser's ad campaign. In some embodiments, the digital advertisement 112 may be any promotional advertisement or message delivered through e-mail, social media websites, online advertising on search engines, banner ads on mobile or websites and affiliate programs, YouTube® advertisements, Google® AdSense, social media stories such as Instagram, Facebook®, Snapchat®, or WhatsApp® stories, radio, SiriusXM®, or Pandora, usually around fifteen seconds long. In various embodiments the platform 200 recommends one or more audio clips to the advertiser that best matches the advertiser's objectives. For example, the platform 200 may recommend twenty audio clips that the platform 200 believes matches the advertiser's objectives based on what the platform 200 knows about the target audience and their mood and emotions around songs as well as metatags of the audio clips. The advertiser may review the list of audio clips and accept some of the songs as meeting their objectives while rejecting others. In some embodiments, there may be a graded scale of how relevant an audio clip is to an advertiser's objectives, and a list of audio clips may be ranked based on the graded scale. For example, one song may be 75% relevant to an advertiser's objectives while another song is 15% relevant. When more than one audio clip is recommended to an advertiser, an advertiser may then select one of the audio clips, and the platform 200 combines the audio clip with the advertiser's visual and/or audio content to create a digital advertisement 112 that may be in the form of a video or audio file, such as an MP4 file, that the advertiser can use across various platforms. In an embodiment where the advertiser chooses not to upload visual or audio content in addition to their objectives, the advertiser can download a watermarked audio file of the selected audio clip that the advertiser can use in their own ad campaign.

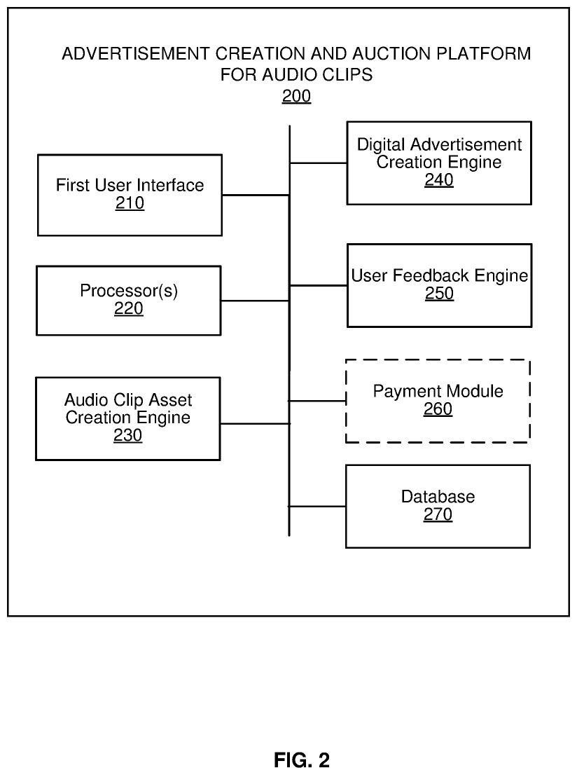

FIG. 2 shows a block diagram illustrating various modules of an advertisement creation and auction platform for audio clips 200, in accordance with various embodiments of the present technology. The platform 200 may include a first user interface 210, a processor 220, an audio clip asset creation engine 230, a digital advertisement creation engine 240, a user feedback engine 250, an optional payment module 260, and a database 270.

The first user interface 210 can be associated with a first user device 104 shown in FIG. 1 and can be configured to receive an advertisement-related request 108 from the first user 102. The ad-related request 108 may include visual and/or audio content uploaded by the advertiser, such as a photo, video, GIF, or audio file, the mood or emotion the advertiser is trying to create, target customers or audience, demographics of the target audience, locations, budget, how many ad impressions the advertiser wants to run, the date the ad campaign should run, the time frame or duration during which the ad campaign should run, and the format of the ad such as mobile, web, or tablet.

In various embodiments the audio clip asset creation engine 230 creates audio clip assets which may include not only the audio file(s) or documents but also the surrounding aspects, properties, tags, and in general, metadata. In some embodiments, the audio clip is less than the full length of an entire song. For example, an audio clip may range from five to thirty seconds in duration. An audio clip asset may include any information related to the audio clip such as BPM, an emotional graph showing how people respond to portions of the song over time and who responds with a particular emotion, an energy level graph showing how the energy level of the song varies over time, fingerprint, frequency highlights, genre, languages, tags per category, access restrictions, tempo, relevancy factor, and the like, as well as how well the song or audio clip has performed in driving consumer behavior in other advertisements such as ad clicks, conversions to paying customers, brand awareness and perception, and customer retention.

According to various embodiments, digital advertisement creation engine 240 can automatically select an audio clip or recommend a list of one or more audio clips to an advertiser based on the advertiser's objectives and audio clip parameters provided by the music industry.

In some embodiments, digital advertisement creation engine 240 can generate a digital ad on the fly to best match an individual. For example, an individual may be served a personalized and specific version of an advertisement based on her previously understood song preferences or what is known about the individual such as demographics (by zip code), age, gender, and other previous interactions the individual had with the platform 200 as well as one or more additional data sources that can be accessed in order to understand more about the target consumers and/or how consumers interact with music that may be stored in the database 106. This personalized information may be stored in database 270. For example, user feedback engine 250 may report back that an individual always clicks on an ad when she hears Aerosmith. Therefore, future digital ads may be paired with Aerosmith for that individual.

In various embodiments, an advertiser may be limited by a budget and/or a minimum bid amount set by the music industry for a particular audio clip. Advertisers can test out specific songs. For example, an advertiser can spend $1,000 in order to see how many conversions into sales or action result from a song so that they can justify a high CPM (cost per thousand) or price point to measure a return on investment (ROI) for the advertiser. If the cost of customer acquisition is too high for the advertiser, the advertiser may need to select a lower priced song to optimize the ROI for the advertiser.

According to various embodiments, digital advertisement creation engine 240 can optimize the songs selected for a digital ad based on the advertiser's budget for an entire ad campaign, how many impressions the advertiser would like, and the minimum bid of audio clips.

In some embodiments digital advertisement creation engine 240 recommends lookalike audiences or ancillary and nearby objectives. For example, an advertiser's target audience may be fifteen to thirty-five-year-old women that feel empowered when they hear a specific song. Digital advertisement creation engine 240 may also recommend to the advertiser a lookalike audience or music associated with the feelings “strong” or “smart”. The original objective of the campaign can be updated based on the objective recommended by the digital advertisement creation engine 240.

In various embodiments the platform 200 decides whether an audio clip is locked in for the entire length of an ad campaign once an audio clip is selected by an advertiser and the digital ad is created, or if there is dynamic pricing, or if digital ads may be updated with new songs on the fly depending on their success or failure. For example, during the course of an ad campaign, a second advertiser can bid more for an audio clip that is already being used in a digital ad being served. If the first advertiser does not have the budget to bid more than the second advertiser, the first advertiser would have to drop down to another relevant audio clip that fits the first advertiser's budget. The platform 200 can optimize for the greatest conversion for an advertiser's campaign based on the advertiser's objectives, the number of impressions, budget, and any changes in the dynamic auction/pricing model over the course of a campaign. For example, the price of an audio clip may be dynamic and may fluctuate over time. Therefore, the platform 200 tracks the real-time demand of an audio clip for dynamic pricing of the audio clip and optimizes a digital ad in real-time depending on demand.

According to various embodiments, an advertiser uploads visual content to the platform 200, and the platform 200 analyzes the visual content and recommends audio clips based on the visual content. For example, the platform 200 detects items within an image or video and decouples from the image or video other assets such as people, objects, scene transitions, and actions. Moreover, a color analysis may be performed on the visual content such as color mapping and background detection, and the like. Further data may be extracted from the visual content such as location, author, tags, timestamps, resolution, image size, as well as any other data elements related to the visual content. An advertiser may request a list of audio clips based on visual matching or the tempo of the visual content and the platform 200 may suggest adjustments to the source video tempo to match closest audio recommendations. Additionally, if the advertiser uploads audio content to the platform 200, the platform 200 may analyze the audio content and recommend audio clips based on the audio content. For example, the platform 200 can understand the text of the audio content. Further data may be extracted from the audio content such as author, tags, timestamps, as well as any other data elements related to the audio content.

In some embodiments, if an advertiser likes a recommended audio clip but the audio clip is slightly in the wrong part of the song, the digital advertisement creation engine 240 may include a scrubber tool to change the length and location of an audio clip that will be licensed. The advertiser can select the precise start and end points of an audio clip that they want to fit their visual and/or audio content. In some instances, digital advertisement creation engine 240 detects the duration of the visual and/or audio content and automatically adjusts a list of audio clips of varying durations to match the duration and the content of the visual and/or audio content.

In some embodiments, user feedback engine 250 monitors and analyzes the success and response to digital advertisements and generates feedback metrics to improve the matching of audio clips to advertiser's visual and/or audio content on demand or in the future. According to various embodiments, user feedback engine 250 measures the number of impressions being generated by a visual or audio digital ad file like an MP4 file. For example, there may be some level of tagging or ad serving to track the number of digital ad impressions delivered. As digital ads are served, user feedback engine 250 tracks the number of plays and determines the amount of money that needs to be paid by the advertiser to the music industry. User feedback engine 250 may also identify the music label or music publishers associated with a particular audio clip. For example, user feedback engine 250 may understand the International Standard Recording Code (ISRC) in order to report back to the music industry how many times an audio clip was licensed for an ad and the actual number of impressions delivered over time.

In some embodiments user feedback engine 250 may also track the number of times a digital ad gets clicked on by end user(s) 120, for example, using cookies, tracking pixels, or any other data tracker. Additionally, the number of actual conversions, such as shopping cart checkouts, email registrations, sharing of an ad, or mobile application downloads, from a digital ad can be tracked, for example, using a conversion pixel. For example, a conversion pixel may be able to provide information that a particular song or music artist may be creating high conversions for a specific person or target audience. Therefore, user feedback engine 250 can recommend that particular song or artist each time the specific person or demographic comes up.

According to exemplary embodiments, the platform 200 may suggest a list of audio clips to an advertiser based on its objectives. However, during the ad campaign, the prices of all the suggested audio clips on the list get bid up too high by other advertisers because of dynamic pricing. The platform 200 can notify the advertiser that its campaign is being delivered much more slowly than anticipated or that the platform cannot meet the advertiser's objectives given the increase in the price of the audio clips. Alternatively, the platform 200 can notify the advertiser that more inventory of audio clips suitable for a particular demographic or objectives is available and recommend a new set of audio clips using audio clips that are not being bid up so quickly and are within the advertiser's budget or audio clips that better meet the advertiser's objectives. In other words, the platform 200 can intelligently and continuously track if ad campaigns are achieving their objectives in a timely manner and within their objectives or determine that parameters have shifted, and new audio clips need to be recommended for approval.

In various embodiments user feedback engine 250 may also proactively recommend audio clips for an advertiser's future campaigns. For example, user feedback engine 250 may notice that an advertiser has run multiple campaigns using specific music artists or audio clips and recommend to the advertiser that they may want to select the same music artist or audio clip for their next campaign. User feedback engine 250 may proactively create ideas for future campaigns that are customized and personalized to an advertiser based on previous campaigns, campaign decisions, and selections by performing optimization in real-time during campaigns and making proactive recommendations and suggestions between campaigns around optimal new music or new findings based upon other campaigns.

In some embodiments, user feedback engine 250 may generate a dashboard showing how the ad campaigns are being delivered, the pricing of various audio clips, online reporting that would allow an advertiser to understand what's happening with their audio clips, the price of audio clips, cost of the ad campaign, whether the ad campaign is meeting its objectives, what music is working best for the advertiser, highest and lowest converting songs, fastest delivered number of impressions, as well as additional reports that can allow an advertiser to have intelligence around their campaigns as well as which audio clips are working best for the advertiser. If the ad campaign is not meeting its objectives, user feedback engine 250 can inform digital advertisement creation engine 240 that changes need to be made and what the changes should be.

In various embodiments the platform 200 may optionally include a payment module 260 to coordinate payments between advertisers and the music industry. In some embodiments, payment module 260 may be an escrow account that advertisers pay into and from which funds get paid to the music industry as digital ads are served. The music industry may be paid on a certain time frame such as daily, weekly, monthly, or annually. In some instances, an advertiser may request a specific number of digital ad impressions to be served, such as 1 million impressions, but there is not enough inventory to fulfill the request. If only 800,000 impressions were served, then advertisers would pay only for 800,000 impressions.

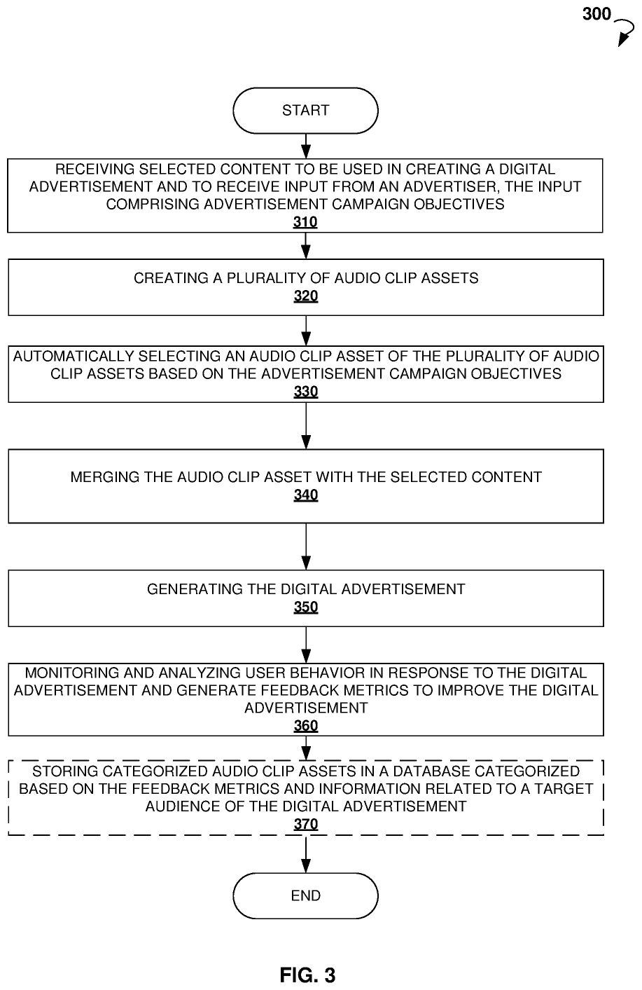

FIG. 3 is a process flow diagram showing a method 300 for creating digital advertisements using an advertisement creation and auction platform according to one or more example embodiments. The method 300 may be performed by processing logic that may comprise hardware (e.g., dedicated logic, programmable logic, and microcode), software (such as software run on a general-purpose computer system or a dedicated machine), or a combination thereof. In one or more example embodiments, the processing logic resides at the platform for audio clips 200.

As shown in FIG. 3, the method 300 may commence at operation 310, with receiving selected content to be used in creating a digital advertisement and to receive input from an advertiser, the input comprising advertisement campaign objectives. For example, the selected content may include visual content uploaded by the advertiser, such as a photo, video, or Graphics Interchange Format (GIF). The selected content may also include audio content uploaded by the advertiser, such as an audio file. The selected content may further include a mood or emotion the advertiser is trying to create, target customers or audience, geographic location of target customers or audience, demographics of the target audience, budget, how many ad impressions the advertiser wants to run, the date that the ad campaign should run, the time-frame or duration during which the ad campaign should run, the format of the advertisement (e.g., mobile, web, or tablet, and the like) and other objectives of the advertiser. In some embodiments, selected content may include both visual and audio content, visual content alone, or audio content alone.

At operation 320, the method 300 may proceed with creating a plurality of audio clip assets. The audio clip assets may include not only the audio file(s) or documents but also the surrounding aspects, properties, tags, and in general, metadata. In some embodiments, the audio clip is less than the full length of an entire song. For example, an audio clip may range from five to thirty seconds in duration. An audio clip asset may include any information related to the audio clip such as such as BPM, an emotional graph showing how people respond to portions of the song over time and who responds with a particular emotion, an energy level graph showing how the energy level of the song varies over time, fingerprint, frequency highlights, genre, languages, tags per category, access restrictions, tempo, and relevancy factor as well as how the audio clip has performed for earlier ad campaigns in terms of consumer response such as click-through rate, conversions, and customer retention, and the like.

At operation 330, the method 300 may include automatically selecting an audio clip asset of the plurality of audio clip assets based on the advertisement campaign objectives. The automatically selecting method may use artificial intelligence and machine learning to optimize the selecting. For example, creating a first training set comprising categorized audio clip assets based on feedback metrics and information related to a target audience of the digital advertisement; training a neural network in a first stage using the first training set; creating a second training set for a second stage of training comprising the first training set and digital advertisements that do not meet the advertisement campaign objectives; and training the neural network in a second stage using the second training set.

At operation 340, the method 300 may proceed with merging the audio clip asset with the selected content. In some embodiments the merging of the audio clip asset with the selected content uses data extracted from visual content, the data extracted comprising color mapping or image identification of the visual content.

At operation 350, the method 300 may include generating the digital advertisement. At operation 360, the method 300 may proceed with monitoring and analyzing user behavior in response to the digital advertisement and generate feedback metrics to improve the digital advertisement. In some embodiments the feedback metrics may be used for creating a first training set for machine learning.

Optionally, at operation 370, the method 300 may proceed with storing categorized audio clip assets in a database categorized based on the feedback metrics and information related to a target audience of the digital advertisement.

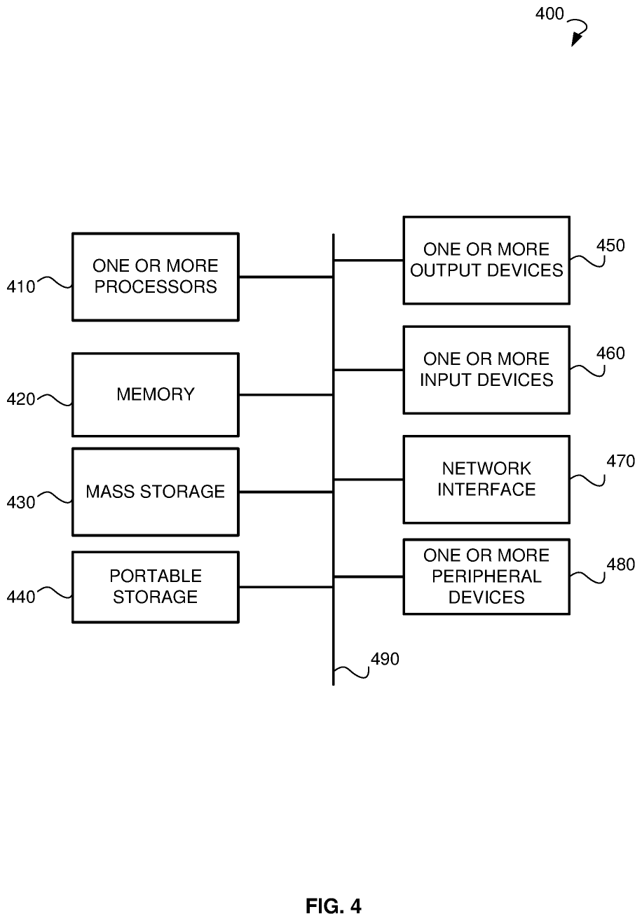

FIG. 4 illustrates an exemplary computing system 400 that may be used to implement embodiments described herein. The computing system 400 of FIG. 4 may include one or more processors 410 and memory 420. Memory 420 stores, in part, instructions and data for execution by the one or more processors 410. Memory 420 can store the executable code when the computing system 400 is in operation. The computing system 400 of FIG. 4 may further include a mass storage 430, portable storage 440, one or more output devices 450, one or more input devices 460, a network interface 470, and one or more peripheral devices 480.

The components shown in FIG. 4 are depicted as being connected via a single bus 490. The components may be connected through one or more data transport means. One or more processors 410 and memory 420 may be connected via a local microprocessor bus, and the mass storage 430, one or more peripheral devices 480, portable storage 440, and network interface 470 may be connected via one or more input/output (I/O) buses.

Mass storage 430, which may be implemented with a magnetic disk drive or an optical disk drive, is a non-volatile storage device for storing data and instructions for use by a magnetic disk or an optical disk drive, which in turn may be used by the one or more processors 410. Mass storage 430 can store the system software for implementing embodiments described herein for purposes of loading that software into memory 420.

Portable storage 440 operates in conjunction with a portable non-volatile storage medium, such as a compact disk (CD) or digital video disc (DVD), to input and output data and code to and from the computing system 400 of FIG. 4. The system software for implementing embodiments described herein may be stored on such a portable medium and input to the computing system 400 via the portable storage 440.

One or more input devices 460 provide a portion of a user interface. One or more input devices 460 may include an alphanumeric keypad, such as a keyboard, for inputting alphanumeric and other information, or a pointing device, such as a mouse, a trackball, a stylus, or cursor direction keys. Additionally, the computing system 400 as shown in FIG. 4 includes one or more output devices 450. Suitable one or more output devices 450 include speakers, printers, network interfaces, and monitors.

Network interface 470 can be utilized to communicate with external devices, external computing devices, servers, and networked systems via one or more communications networks such as one or more wired, wireless, or optical networks including, for example, the Internet, intranet, LAN, WAN, cellular phone networks (e.g. Global System for Mobile communications network, packet switching communications network, circuit switching communications network), Bluetooth radio, and an IEEE 802.11-based radio frequency network, among others. Network interface 470 may be a network interface card, such as an Ethernet card, optical transceiver, radio frequency transceiver, or any other type of device that can send and receive information. Other examples of such network interfaces may include Bluetooth®, 3G, 4G, and WiFi® radios in mobile computing devices as well as a USB.

One or more peripheral devices 480 may include any type of computer support device to add additional functionality to the computing system 400. One or more peripheral devices 480 may include a modem or a router.

The components contained in the computing system 400 of FIG. 4 are those typically found in computing systems that may be suitable for use with embodiments described herein and are intended to represent a broad category of such computer components that are well known in the art. Thus, the computing system 400 of FIG. 4 can be a PC, handheld computing device, telephone, mobile computing device, workstation, server, minicomputer, mainframe computer, or any other computing device. The computer can also include different bus configurations, networked platforms, multi-processor platforms, and so forth. Various operating systems (OS) can be used including UNIX, Linux, Windows, Macintosh OS, Palm OS, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the example embodiments. Those skilled in the art are familiar with instructions, processor(s), and storage media.

It is noteworthy that any hardware platform suitable for performing the processing described herein is suitable for use with the example embodiments. The terms “computer-readable storage medium” and “computer-readable storage media” as used herein refer to any medium or media that participate in providing instructions to a central processing unit (CPU) for execution. Such media can take many forms, including, but not limited to, non-volatile media, volatile media, and transmission media. Non-volatile media include, for example, optical or magnetic disks, such as a fixed disk. Volatile media include dynamic memory, such as Random-Access Memory (RAM). Transmission media include coaxial cables, copper wire, and fiber optics, among others, including the wires that include one embodiment of a bus. Transmission media can also take the form of acoustic or light waves, such as those generated during radio frequency and infrared data communications. Common forms of computer-readable media include, for example, a floppy disk, a flexible disk, a hard disk, magnetic tape, any other magnetic medium, a CD-read-only memory (ROM) disk, DVD, any other optical medium, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

In some embodiments, the computing system 400 may be implemented as a cloud-based computing environment, such as a virtual machine operating within a computing cloud. In other embodiments, the computing system 400 may itself include a cloud-based computing environment, where the functionalities of the computing system 400 are executed in a distributed fashion. Thus, the computing system 400, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud may be formed, for example, by a network of web servers that comprise a plurality of computing devices, such as the computing system 400, with each server (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

Aspects of the present technology are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams illustrate the architecture, functionality, and operation of possible implementations of systems, methods and computer program products according to various embodiments of the present technology. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, methods and systems for implementing and using an advertisement creation and auction platform for audio clips have been described. Although embodiments have been described with reference to specific example embodiments, it will be evident that various modifications and changes can be made to these example embodiments without departing from the broader spirit and scope of the present application. Accordingly, the specification and drawings are to be regarded in an illustrative rather than a restrictive sense. There are many alternative ways of implementing the present technology. The disclosed examples are illustrative and not restrictive.

What is claimed is:

1. A system for creating digital advertisements using an advertisement creation and auction platform, the system comprising:
a first interface configured to select content to be used in creating a digital advertisement and to receive input from an advertiser, the input comprising advertisement campaign objectives;
an audio clip asset creation engine configured to create a plurality of audio clip assets;
a digital advertisement creation engine configured to automatically select an audio clip asset of the plurality of audio clip assets based on the advertisement campaign objectives, merge the audio clip asset with the content, and generate the digital advertisement; and
a user feedback engine configured to monitor and analyze user behavior in response to the digital advertisement and generate feedback metrics to improve the digital advertisement.

2. The system of claim 1, further comprising a database, the database storing categorized audio clip assets categorized based on the feedback metrics and information related to a target audience of the digital advertisement.

3. The system of claim 2, wherein the digital advertisement creation engine is further configured to create a first training set comprising the categorized audio clip assets based on the feedback metrics and the information related to a target audience of the digital advertisement;
train a neural network in a first stage using the first training set;
create a second training set for a second stage of training comprising the first training set and digital advertisements that do not meet the advertisement campaign objectives; and
train the neural network in a second stage using the second training set.

4. The system of claim 3, wherein the digital advertisement creation engine is further configured to automatically select an optimized audio clip asset of the categorized audio clip assets using the advertisement campaign objectives, the information related to a target audience of the digital advertisement, the first training set, and the second training set.

5. The system of claim 3, wherein the digital advertisement creation engine is further configured to automatically select a plurality of optimized audio clip assets of the categorized audio clip assets using the advertisement campaign objectives, the information related to a target audience of the digital advertisement, the first training set, and the second training set, the plurality of optimized audio clip assets being given a relative graded scale to the advertisement campaign objectives.

6. The system of claim 1, wherein the content comprises visual content and the merge of the audio clip asset with the content uses data extracted from the visual content, the data extracted comprising color mapping of the visual content.

7. The system of claim 1, wherein the advertisement campaign objectives of the digital advertisement comprise one or more: a mood, an emotion, target customers, geographic location of target customers, demographics of a target audience, budget, a number of ad impressions, a date for an ad campaign, a time-frame for an ad campaign, a duration for an ad campaign, a format, and performance objectives of the digital advertisement.

8. The system of claim 1, wherein the plurality of audio clip assets comprise a set of audio clip parameters, the set of audio clip parameters for each audio clip asset of the plurality of audio clip assets comprising at least one or more of: licensing availability, a minimum bid, and a maximum number of impressions.

9. The system of claim 1, wherein the plurality of audio clip assets are fully licensed and are a duration of fifteen seconds or less.

10. A method for creating digital advertisements using an advertisement creation and auction platform, the method comprising:
receiving selected content to be used in creating a digital advertisement and to receive input from an advertiser, the input comprising advertisement campaign objectives;
creating a plurality of audio clip assets;
automatically selecting an audio clip asset of the plurality of audio clip assets based on the advertisement campaign objectives;
merging the audio clip asset with the selected content;
generating the digital advertisement; and
monitoring and analyzing user behavior in response to the digital advertisement and generate feedback metrics to improve the digital advertisement.

11. The method of claim 10, further comprising storing categorized audio clip assets in a database categorized based on the feedback metrics and information related to a target audience of the digital advertisement.

12. The method of claim 11, further comprising:
creating a first training set comprising the categorized audio clip assets based on the feedback metrics and the information related to a target audience of the digital advertisement;
training a neural network in a first stage using the first training set;
creating a second training set for a second stage of training comprising the first training set and digital advertisements that do not meet the advertisement campaign objectives; and
training the neural network in a second stage using the second training set.

13. The method of claim 12, further comprising automatically selecting an optimized audio clip asset of the categorized audio clip assets using the advertisement campaign objectives, the information related to a target audience of the digital advertisement, the first training set, and the second training set.

14. The method of claim 12, further comprising automatically selecting a plurality of optimized audio clip assets of the categorized audio clip assets using the advertisement campaign objectives, the information related to a target audience of the digital advertisement, the first training set, and the second training set, the plurality of optimized audio clip assets being given a relative graded scale to the advertisement campaign objectives.

15. The method of claim 10, wherein the selected content comprises visual content and the merging of the audio clip asset with the selected content uses data extracted from the visual content, the data extracted comprising color mapping of the visual content.

16. The method of claim 10, wherein the advertisement campaign objectives of the digital advertisement comprise one or more: a mood, an emotion, target customers, geographic location of target customers, demographics of a target audience, budget, a number of ad impressions, a date for an ad campaign, a time-frame for an ad campaign, a duration for an ad campaign, a format, and performance objectives of the digital advertisement.

17. The method of claim 10, wherein the plurality of audio clip assets comprise a set of audio clip parameters, the set of audio clip parameters for each audio clip asset of the plurality of audio clip assets comprising at least one or more of: licensing availability, a minimum bid, and a maximum amount of impressions.

18. The method of claim 10, wherein the plurality of audio clip assets are fully licensed and are a duration of fifteen seconds or less.

19. A non-transitory computer readable medium having embodied thereon instructions being executable by at least one processor to perform a method for creating digital advertisements using an advertisement creation and auction platform, the method comprising:
receiving selected content to be used in creating a digital advertisement and to receive input from an advertiser, the input comprising advertisement campaign objectives;
creating a plurality of audio clip assets;
automatically selecting an audio clip asset of the plurality of audio clip assets based on the advertisement campaign objectives;
merging the audio clip asset with the selected content;
generating the digital advertisement; and
monitoring and analyzing user behavior in response to the digital advertisement and generate feedback metrics to improve the digital advertisement.

20. The non-transitory computer readable medium of claim 19, wherein the method further comprises storing categorized audio clip assets in a database categorized based on the feedback metrics and information related to a target audience of the digital advertisement.

21. The non-transitory computer readable medium of claim 20, wherein the method further comprises:
creating a first training set comprising the categorized audio clip assets based on the feedback metrics and the information related to a target audience of the digital advertisement;
training a neural network in a first stage using the first training set;
creating a second training set for a second stage of training comprising the first training set and digital advertisements that do not meet the advertisement campaign objectives; and
training the neural network in a second stage using the second training set.
